(19) United States
(12) Patent Application Publication
(10) Pub. No.: US 2017/0293461 A1
(43) Pub. Date: Oct. 12, 2017

(54) GRAPHICAL PLACEMENT OF IMMERSIVE AUDIO SOURCES

(71) Applicant: VideoStitch Inc., San Francisco, CA (US)

(72) Inventors: Lucas McCauley, Vincennes (FR); Stéphane Valente, Paris (FR); Alexander Fink, San Jose, CA (US); Nicolas Burtey, Mountain View, CA (US)

(21) Appl. No.: 15/093,121

(22) Filed: Apr. 7, 2016

(51) Int. Cl. G06F 3/16; G06F 3/0484; H04S 3/00; G06F 3/0481

(52) U.S. Cl. CPC G06F 3/165; G06F 3/04817; G06F 3/04845; H04S 3/002; H04S 2400/01; H04S 2400/11; H04S 2420/11

(57) ABSTRACT

A system comprising a video source, one or more audio sources and a computing device. The video source may be configured to generate a video signal. The audio sources may be configured to generate audio streams. The computing device may comprise one or more processors configured to (i) transmit a display signal that provides a representation of the video signal to be displayed to a user, (ii) receive a plurality of commands from the user while the user observes the representation of the video signal and (iii) adjust the audio streams in response to the commands. The commands may identify a location of the audio sources in the representation of the video signal. The representation of the video signal may be used as a frame of reference for the location of the audio sources.

### FIELD OF THE INVENTION

The invention relates to audio and video generally and, more particularly, to a method and/or apparatus for implementing a graphical placement of immersive audio sources.

### BACKGROUND

Three-dimensional audio can be represented in B-format audio (ambisonics) or in an object-audio format (i.e., Dolby Atmos) by “panning” a monophonic audio source in 3D space using two angles (conventionally identified as θ and φ). Ambisonics uses at least four audio channels (i.e., first-order B-format audio) to encode an entire 360° sound sphere. Object audio uses monophonic or stereophonic audio “objects” with associated metadata for indicating position to a proprietary renderer. Audio “objects” with associated metadata are often panned (or placed) using a technique referred to as vector base amplitude panning (VBAP). A 360° video can be represented in various formats as well, such as 2D equirectangular, cubic projections, or through a head-mounted display (i.e., an Oculus Rift).

A perceived distance of a sound is a function of level and frequency. High frequencies are more readily absorbed by air, and level decreases with distance by an inverse square law. Low frequencies are boosted at close range due to the proximity effect in most microphones (i.e., in all but true omni pattern microphones).

Conventional tools for adding audio to 360 degree video allow a graphical placement of audio objects in 3D space, through a Unity game engine plugin. Three-dimensional objects are placed with an associated sound, which is rendered as 3D binaural audio. The conventional tools do not place audio sources relative to video, but rather to synthetic images. The conventional tools are directed to binaural rendering.

Other conventional solutions for mixing in three dimensions are aimed at audio-only workstations. Audio-only workstation solutions are usually vendor-specific (i.e., mixing tools for Dolby Atmos or the 3D mixing suite by Auro). In audio-only workstation solutions a creator places audio based on a simple graphical representation and do not interface directly with the 360° video. Conventional vendor-specific tools (or conventional 3D mixing tools) that are designed for discrete or ambisonic formats do not allow for placement based directly on a corresponding point in a video. The creator (or mixer) has to place the sounds by ear while playing the video and see if the input settings coincide with the desired position.

A paper titled “Audio-Visual Processing Tools for Auditory Scene Synthesis” (AES Convention Paper No. 7365) was presented by Kearney, Dahyot, and Boland in May 2008. The paper presents a system for placing audio sources visually on a video using VBAP, with automatic object tracking. The solution proposed in the paper is directed to VBAP, and does not handle distance.

Conventional audio mixing solutions are also based on a fixed reference point (i.e., front). If one of these conventional tools is used for mixing, and the 360° video is rotated, the mix would need to be redone, or the soundfield realigned in some other way.

It would be desirable to implement a graphical placement of immersive audio sources.

### SUMMARY

The invention concerns a system comprising a video source, one or more audio sources and a computing device. The video source may be configured to generate a video signal. The audio sources may be configured to generate audio streams. The computing device may comprise one or more processors configured to (i) transmit a display signal that provides a representation of the video signal to be displayed to a user, (ii) receive a plurality of commands from the user while the user observes the representation of the video signal and (iii) adjust the audio streams in response to the commands. The commands may identify a location of the audio sources in the representation of the video signal. The representation of the video signal may be used as a frame of reference for the location of the audio sources.

### BRIEF DESCRIPTION OF THE FIGURES

Embodiments of the invention will be apparent from the following detailed description and the appended claims and drawings in which:

FIG. 1 is a diagram illustrating a system according to an example embodiment of the present invention;

FIG. 2 is a diagram illustrating an example interface;

FIG. 3 is a diagram illustrating an alternate example interface;

FIG. 4 is a diagram illustrating tracking an audio source;

FIG. 5 is a diagram illustrating determining B-format signals;

FIG. 6 is a diagram illustrating a graphical representation of an audio source;

FIG. 7 is a flow diagram illustrating a method for generating an interface to allow a user to interact with a video file to place audio sources;

FIG. 8 is a flow diagram illustrating a method for identifying an audio source and adjusting an audio stream;

FIG. 9 is a flow diagram illustrating a method for specifying a location for audio sources;

FIG. 10 is a flow diagram illustrating a method for automating position and distance parameters;

FIG. 11 is a flow diagram illustrating a method for calculating B-format signals; and

FIG. 12 is a flow diagram illustrating a method for scaling a size of an icon identifying an audio source.

### DETAILED DESCRIPTION OF THE EMBODIMENTS

Embodiments of the invention include implementing a graphical placement of immersive audio sources that may (i) provide a user an interface for placing audio sources for a video source, (ii) allow a user to interact with a video source, (iii) allow a user to place an audio object graphically in a spherical field of view, (iv) allow a user to set a distance of an audio source, (v) perform automatic distance determination for an audio source, (vi) be technology-agnostic, (vii) allow a user to set a direction for an audio source, (viii) create a graphical representation for an audio source, (ix) automatically adjust audio source placement using sensors (x) determine distance using triangulation, (xi) determine distance using depth maps (xii) perform audio processing, (xii) track an audio source and/or (xiii) be cost-effective to implement.

When combining immersive video and audio, a creator may want to place audio sources at a specific location in an immersive audio sound field relative to a 360° video. In an example, an audio source may comprise recordings taken by microphones (e.g., lapel microphones, boom microphones and/or other microphones near the object making sounds). In another example, audio sources may be synthetic (or created) sound effects (e.g., stock audio, special effects, manipulated audio, etc.). A video source may be an immersive video, a spherical video, a 360 degree (or less) video, an equirectangular representation of a captured video, etc. In an example, the video source may be a stitched video comprising a spherical field of view (e.g., a video stitched together using data from multiple image sensors). Embodiments of the present invention propose a simple way to place an audio source for a video source through a graphical user interface.

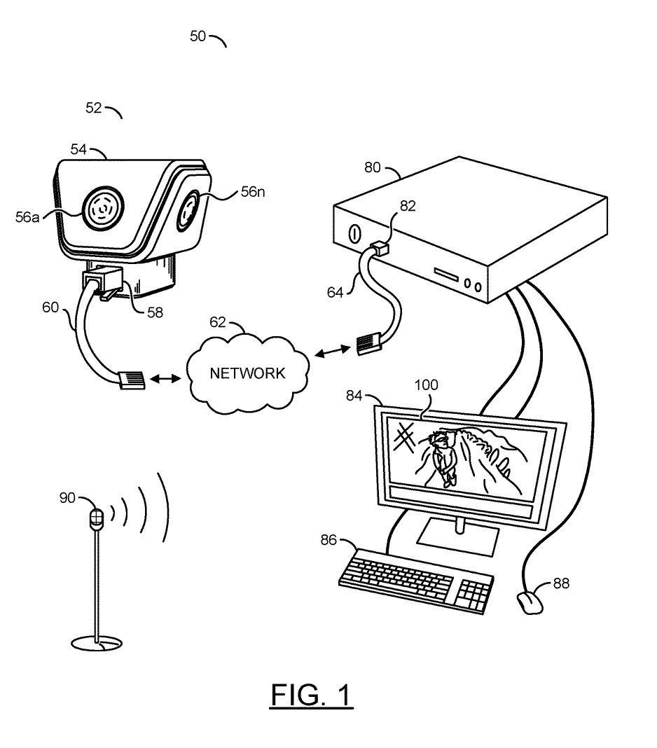

Referring to FIG. 1, a diagram illustrating a system 50 according to an example embodiment of the present invention is shown. The system 50 may comprise a capture device 52, a network 62, a computing device 80, an audio capture device 90 and/or an interface 100. The system 50 may be configured to capture video of an environment surrounding the capture device 52, capture audio of an environment surrounding the audio capture device 90, transmit the video and/or audio to the computing device 80 via the network 62, and allow a user to interact with the video and audio with the interface 100. Other components may be implemented as part of the system 50.

The capture device 52 may comprise a structure 54, lenses 56a-56n, and/or a port 58. Other components may be implemented. The structure 54 may provide support and/or a frame for the various components of the capture device 52. The lenses 56a-56n may be arranged in various directions to capture the environment surrounding the capture device 52. In an example, the lenses 56a-56n may be located on each side of the capture device 52 to capture video from all sides of the capture device 52 (e.g., provide a video source, such as a spherical field of view). The port 58 may be configured to enable communications and/or power to be transmitted and/or received. The port 58 is shown connected to a wire 60 to enable communication with the network 62. In some embodiments, the capture device 52 may also comprise an audio capture device (e.g., a microphone) for capturing audio sources surrounding the capture device 52.

The computing device 80 may comprise memory and/or processing components for performing video and/or audio encoding operations. The computing device 80 may be configured to perform video stitching operations. The computing device 80 may be configured to read instructions and/or execute commands. The computing device 80 may comprise one or more processors. The processors of the computing device 80 may be configured to analyze video data and/or perform computer vision techniques. In an example, the processors of the computing device 80 may be configured to automatically determine a location of particular objects in a video frame. The computing device 80 may comprise a port 82. The port 82 may be configured to enable communications and/or power to be transmitted and/or received. The port 82 is shown connected to a wire 64 to enable communication with the network 62. The computing device 80 may comprise various input/output components to provide a human interface. A display 84, a keyboard 86 and a pointing device 88 are shown connected to the computing device 80. The keyboard 86 and/or the pointing device 88 may enable human input to the computing device 80. The display 84 is shown displaying the interface 100. In some embodiments, the display 84 may be configured to enable human input (e.g., the display 84 may be a touchscreen device).

The computing device 80 is shown as a desktop computer. In some embodiments, the computing device 80 may be a mini computer. In some embodiments, the computing device 80 may be a micro computer. In some embodiments, the computing device 80 may be a notebook (laptop) computer. In some embodiments, the computing device 80 may be a tablet computing device. In some embodiments, the computing device 80 may be a smartphone. The format of the computing device 80 and/or any peripherals (e.g., the display 84, the keyboard 86 and/or the pointing device 88) may be varied according to the design criteria of a particular implementation.

The audio capture device 90 may be configured to capture audio (e.g., sound) sources from the environment. Generally, the audio capture device 90 is located near the capture device 52. The audio capture device 90 is shown as a microphone. In some embodiments, the audio capture device 90 may be implemented as a lapel microphone. For example, the audio capture device 90 may be configured to move around the environment (e.g., follow the audio source). The implementation of the audio device 90 may be varied according to the design criteria of a particular implementation.

The interface 100 may enable a user to place audio sources in a “3D” or “immersive” audio soundfield relative to a 360° video. The interface 100 may be a graphical user interface (GUI). The interface 100 may allow the user to place an audio object (e.g., a recorded audio source) graphically in the spherical view. The interface 100 may allow the user to graphically set a distance of the audio object in the spherical view. In some embodiments, the interface 100 may be configured to perform an automatic distance determination. The interface 100 may be technology-agnostic. For example, the interface 100 may work with various audio formats (e.g., B-format equations for ambisonic-based audio, metadata for object audio-based systems, etc.) and/or video formats.

In some embodiments, the video source may be a 360 degree video and the audio sources may be sound fields and the user may click on an equirectangular projection 102. In some embodiments, the user may indicate a desired direction (e.g., a location) of the sound source by clicking on the rectilinear view (e.g., the non-spherical standard projection of cameras) and the audio source may be translated (e.g., converted) to a stereo sound track, multichannel sound tracks and/or an immersive sound field. The type of video source and/or audio source edited using the interface 100 may be varied according to the design criteria of a particular implementation.

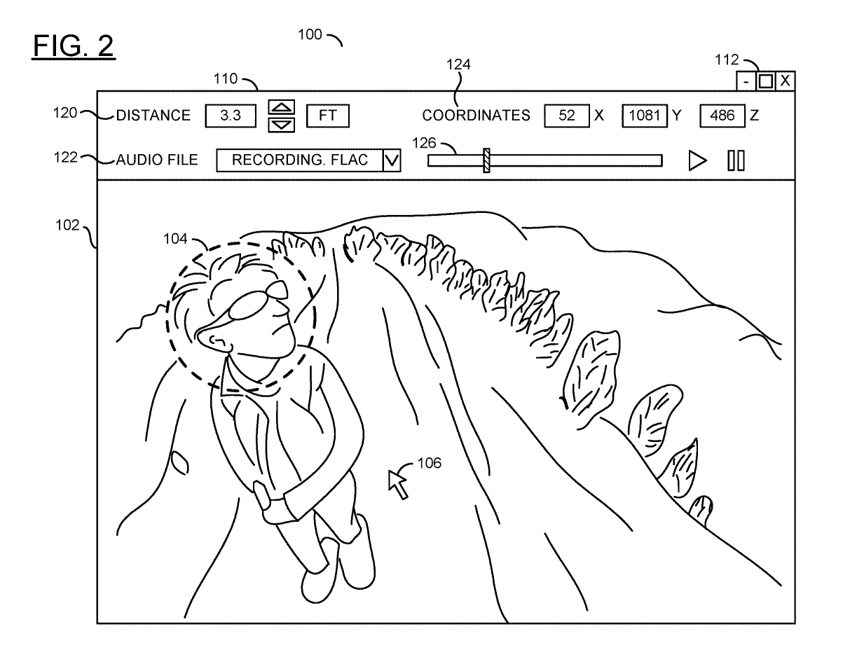

Referring to FIG. 2, a diagram illustrating the example interface 100 is shown. The interface 100 may comprise a video portion 102 and a GUI portion 110. The video portion 102 may be a video frame. The video frame 102 may be a representation of a video signal (e.g., a spherical field of view, a 360 degree video, a virtual reality video, etc.). In an example, the video representation 102 may show one portion of the video signal, and the user may interact with the interface 100 to show other portions of the video signal (e.g., rotate the spherical field of view). The video frame 102 may be a 2D equirectangular projection of the spherical field of view onto a two-dimensional surface (e.g., the display 84). The GUI portion 110 may comprise various input parameters and/or information. The GUI portion 110 may allow the user to manipulate the video and/or audio. In the example shown, the GUI portion 110 is located above the video portion 102. The arrangement of the video portion 102 and/or the GUI portion 110 may be varied according to the design criteria of a particular implementation.

The video frame 102 provides a view of the environment surrounding the capture device 52 to the user. In the example shown, the video frame 102 comprises a person standing outdoors. The person speaking may be an audio source. For example, the audio capture device 90 may record the audio source when the person speaks. The recording by the audio capture device 90 may be an audio stream. In some embodiments, the audio stream may be a raw audio file. In some embodiments, the audio stream may be an encoded and/or compressed audio file.

The audio source is identified by a graphical indicator 104 on the video frame 102. The graphical indicator 104 may correspond to the location of the audio source. The graphical indicator 104 may be an icon. In the example shown, the icon 104 is a dashed circle around the audio source (e.g., the head of the person speaking). In some embodiments, the icon may be an ellipse, a rectangle, a cross and/or a user-selected image. In some embodiments, multiple icons 104 may be selected for multiple audio sources (e.g., each audio source may be identified with a different icon 104). The style of the icon 104 may be varied according to the design criteria of a particular implementation.

A pointer 106 is shown on the video portion 102. The pointer 106 may allow the user to interact with the video frame 102 and/or the GUI portion 110. The pointer 106 may be manipulated by the pointing device 88 and/or the keyboard 86. The pointer 106 may be native to the operating system of the computing device 80. In an example, the pointer 106 may be used to select the audio source and place the icon 104 (e.g., the user clicks or taps the location of the audio source with the pointer 106 to place the icon 104 for the audio source). In some embodiments, the pointer 106 may be used to rotate the spherical video to show alternate regions of the video frame 102 (e.g., display a different representation of the video source on the display 84).

The GUI portion 110 may comprise operating system icons 112. The operating system icons 112 may be part of a native GUI for the operating system of the computing device 80 implemented by the interface 100. For example, the operating system icons 112 may be a user interface overhead (e.g., chrome) surrounding the GUI portion 110 and/or the video frame 102. The operating system icons 112 may be varied based on the operating system (e.g., Windows, Linux, iOS, Android, etc.). The visual integration of the interface 100 with the operating system of the computing device 80 may be varied according to the design criteria of a particular implementation.

The GUI portion 110 may comprise a distance parameter 120. The distance parameter 120 may identify a distance of the audio source. The distance parameter 120 may identify a location of the audio source. In the example shown, the user may type in and/or use the pointer 106 to adjust the distance parameter 120. The distance parameter 120 may be measured in feet, meters and/or any other distance measurement. The distance parameter 120 may be a measurement of the location of the audio source from an origin point of the video source (e.g., the location of the capture device 52). In the example shown, the person speaking (e.g., the audio source) may be 3.3 feet from the capture device 52.

The GUI portion 110 may comprise an audio file parameter 122. The audio file parameter 122 may be a selected audio stream. The audio stream may be the audio data stored (e.g., in the memory of the computing device 80) in response to the audio source. In the example shown, the audio stream is a file named “Recording.FLAC”. The audio file parameter 122 may be selected from a list (e.g., a drop-down list). The audio file parameter 122 may be used to associate the audio stream with the audio source. In the example, shown, the user may identify the audio source (e.g., the person speaking) with the icon 104 and associate the audio source with the audio stream by selecting the audio file parameter 122. The type of files used for the audio file parameter 122 may be varied according to the design criteria of a particular implementation.

The GUI portion 110 may comprise coordinate parameters 124. The coordinate parameters 124 may indicate a location of the audio source (e.g., the icon 104) on the video frame 102. In some embodiments, the coordinate parameters 124 may be entered manually and/or selected by placing the icon 104. In the example shown, the coordinate parameters 124 are in a Cartesian format. In some embodiments, the coordinate parameters 124 may be in a polar coordinate format. The coordinate parameters 124 may represent a location of the audio source with respect to the video source (e.g., the capture device 52).

The GUI portion 110 may comprise a timeline 126. The timeline 126 is shown as a marker passing over a set distance to indicate an amount of playback time left for a file. Play and pause buttons are also shown. The timeline 126 may correspond to the video signal and/or one or more of the audio streams. In some embodiments, more than one timeline 126 may be implemented. For example, one of the timelines 126 may correspond to the video signal and another timeline 126 may correspond to the audio file parameter 122 and/or any other additional audio streams used. The timeline 126 may enable a user to synchronize the audio streams to the video signal. The style of the timeline 126 and/or number of timelines 126 may be varied according to the design criteria of a particular implementation.

The interface 100 may be configured to enable the user to place the audio object graphically (e.g., using the icon 104) in the spherical view 102. The user may indicate other points on the video 102 to place audio sources. The audio source may be placed in the immersive sound field based on the spherical video coordinates 124 of the point 104 indicated in the interface 100. The audio stream may be associated with the audio source.

The user may be able to indicate which audio resource (e.g., the audio file parameter 122) to place. For example, the user may indicate the audio file parameter 122 using a “select” button in a timeline view (e.g., using the timeline 126), dragging a file from a list to a point on the screen (e.g., using the drop-down menu shown), and/or creating a point (e.g., the icon 104) and editing properties to attach a source file.

The user may use the interface 100 to place the audio source relative to the 360° video (e.g., the video portion 102). The audio stream (e.g., the audio file parameter 122) may be associated with the placed audio source. The 3D position of the audio source may be represented using the coordinate parameters 124. For example, the coordinate parameters may be represented by xyz (e.g., Cartesian) or rθφ (e.g., polar) values. The polar system for the coordinate parameters 124 may have an advantage of the direction and distance being distinctly separate (e.g., when modifying the distance, only the parameter r changes, while in Cartesian, any or all values of x, y and z may change). The polar system for the coordinate parameters 124 may be used in the equations for placing the audio sources in ambisonics (B-format) and/or VBAP.

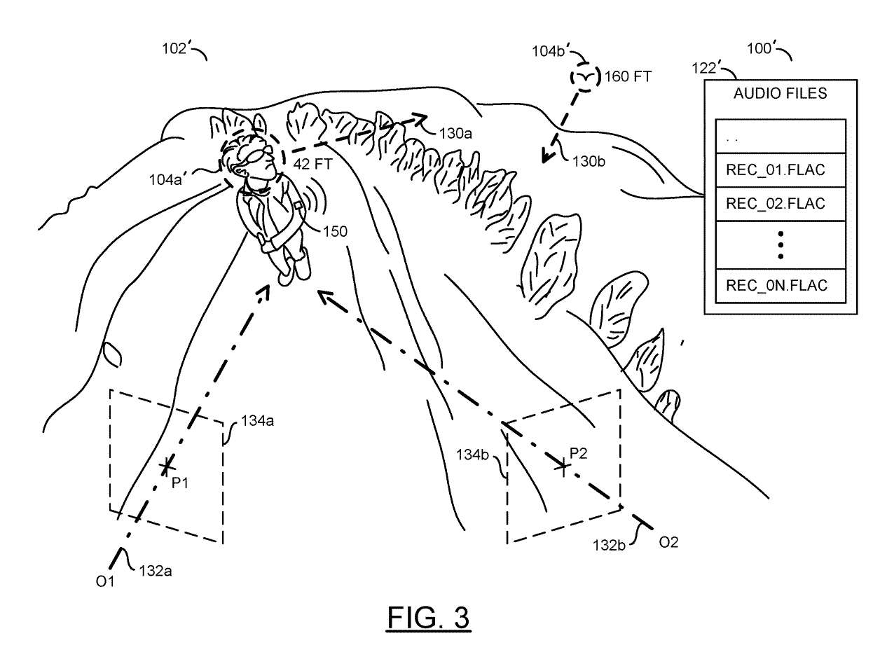

Referring to FIG. 3, a diagram illustrating an alternate example interface 100′ is shown. The alternate interface 100′ shows the interface 100′ having a larger video portion 102′. The alternate interface 100′ may have a limited GUI portion 110 to allow the user to see more of the video portion 102′.

The person is shown farther away in the video frame 102′ (e.g., compared to the location of the person shown in FIG. 2). Since the location of the audio source (e.g., the person speaking) is farther away from the video source (e.g., the capture device 52) the icon 104a′ is shown having a smaller size. For example, the size of the icon 104a′ may be based on the distance of the audio source. The icon 104a′ is shown having a label indicating the distance parameter 120. The label for the distance parameter 120 is shown as “42 FT”.

The interface 100′ may enable the user to indicate a direction of the audio source. In the example shown, the person speaking is shown looking to one side. The audio direction parameter 130a may indicate the direction of the audio source. In the example shown, the audio direction parameter 130a is shown pointing in a direction of the head of the person speaking (e.g., the audio source). In an example, the user may place the direction on the interface 100′ by clicking (or tapping) and dragging the direction parameter 130a to point in a desired direction.

The coordinate parameters 124 may be defined for the audio source relative to the video source. The coordinate parameters 124 may be set manually and/or determined automatically. In an example, manual entry of the coordinate parameters 124 may be performed by clicking with the mouse 88 on a 2D projection of the video (e.g., the representation of the video 102′). In another example, the user may center the video source using a head-mounted display and pressing a key/button. In yet another example, any other means of specifying a point in 3D space (e.g., manually entering coordinates on the GUI portion 110) may be used. Automatic placement may be performed by detecting a direction (or position) of the audio source in a 3D sound field, using an emitter/receiver device combination, and/or using computer vision techniques. The method of determining the coordinate parameters 124 may be varied according to the design criteria of a particular implementation.

The coordinate parameters 124 may be implemented using polar coordinates. For example, the θ and φ coordinates may be measured relative to the center of an equirectangular projection of the 360° video (e.g., a reference point). The reference point may be the point where θ=0 and φ=0. The reference point has been adopted by playback devices such as the Oculus Rift and YouTube, and is suggested in the draft Spherical Video Request for Comments (RFC) issued by the Internet Engineering Task Force (IETF). Using the polar coordinates and the reference point as the coordinate parameters 124, values for W and XYZ ambisonic B-format signals with four equations (or more for higher order ambisonics) may be calculated. For VBAP, any transformation and/or formatting (if necessary) of the polar coordinate parameters 124 may be determined based on a particular immersive audio format vendor. If the center of the 2D projection is moved during video creation, the icons 104a′-104b′ should follow the associated pixels and the coordinate parameters 124 may be adjusted accordingly.

The interface 100′ may enable identifying multiple audio sources in the spherical video frame 102′. In the example shown, a bird is captured in the background. An icon 104b′ is shown identifying the bird as an audio source. The icon 104b′ is shown smaller than the icon 104a′ since the bird is farther away from the person speaking. The icon 104b′ may have a label indicating the distance. In the example shown, the label for the icon 104b′ is “160 FT”. The icon 104b′ may have a direction indicator 130b.

The GUI portion 110 is shown as an unobtrusive menu (e.g., a context menu) for the audio file parameter 122′. The audio file parameter 122′ is shown as a list of audio stream files. The user may provide commands to the interface 100′ to place the audio streams graphically on the video portion 102′. In some embodiments, different audio streams may be selected for each audio source. In an example, the user may click on the bird (e.g., the audio source) to place the icon 104b′. The distance may be determined (e.g., entered manually, or calculated automatically). The user may right-click (e.g., using the pointing device 88) on the icon 104b′ and a context menu with the audio file parameters 122′ may open. The user may select one of the audio streams from the list of audio streams in the audio file parameters 122′ to associate an audio stream with the audio source. The user may click and drag to indicate the direction parameter 130b.

The location of the audio sources may be indicated graphically (e.g., the icons 104a′-104b′). The size of the graphical indicators 104a′-104b′ may correspond to the distance of the respective audio source. Since an audio source that is farther away may sound quieter than an audio source with a similar amplitude (e.g., level) that is closer, a maximum range may be set to keep distant sources audible. Associating the audio streams with the audio sources may be technology-agnostic. In one example, the audio sources may be placed on the spherical view 102 in ambisonic-based audio systems with B-format equations. In another example, the audio sources may be placed on the spherical view 102 using metadata created for object audio-based systems. The audio streams may be adjusted using the B-format equations and/or the metadata for object audio-based systems.

In some embodiments, the distance of the audio sources may be determined automatically. If the object that is the audio source (e.g., the person speaking) is visible by two or more cameras (e.g., more than one of the lenses 56a-56n), it may be possible to triangulate the distance of the audio source from the capture device 52 and automatically set the audio source distance (e.g., the distance parameter 120).

In some embodiments, triangulation may be implemented to determine the distance parameter 120. The capture device 52 may be calibrated (e.g., the metric relationship between the projections formed by the lenses 56a-56n on the camera sensors and the physical world is known). For example, if the clicked point (e.g., the icon 104a′) in the spherical projection 102′ is actually viewed by two distinct cameras having optical centers that do not coincide, the parallax may be used to automatically determine the distance of the audio source from the capture device 52.

Lines 132a-132b may represent light passing through respective optical centers (e.g., O1 and O2) to the audio source identified by the icon 104a′. In the example shown, the cameras having the optical centers O1 and O2 may be rectilinear. In some embodiments, similar calculations may apply to cameras implemented as an omnidirectional camera having fisheye lenses. Planes 134a-134b may be image planes of two different cameras (e.g., the lenses 56a-56b). The audio source identified by the icon 104a′ may be projected at points P1 and P2 on the image planes 134a-134b of the lenses 56a-56b on the lines 132a-132b passing through the optical centers O1 and O2 of the cameras. If the cameras are calibrated, the metric coordinates of points O1, P1, O2 and P2 may be known. Using the coordinates of points O1, P1, O2 and P2 equations of lines (O1P1) and (O2P2) may be determined. From the two equations of lines (O1P1) and (O2P2), the metric coordinates of the icon 104a′ may be determined at the intersection of both lines 132a-132b, and the distance of the clicked object (e.g., the audio source) to the camera rig may be determined.

In some embodiments, the distance parameter 120 may be detected using a sensor 150. In the example shown, the sensor 150 is shown on the person speaking. For example, the sensor 150 may be a wireless transmitter, a depth-of-flight sensor, a LIDAR device, a structured-light device, a receiver and/or a GPS device. The distance parameter 120 may be calculated using data captured by the sensor 150. In an example, the user may click a location (e.g., place the icon 104a′) on the flat projection 102′ to indicate the coordinate parameters 124 of where the audio source is supposed to originate. Then, sensors 150 may be used to measure the distance between the icon 104a′ and the capture device 104a′. In some embodiments, the sensor 150 may be circuits placed on a lapel microphone (e.g., the audio capture device 90) and/or an object of interest and the capture device 52 may be configured to communicate wirelessly to determine the distance parameter 120. In some embodiments, the sensor 150 may be a GPS chipset (e.g., on the lapel microphone 90 and/or on an object of interest) communicating wirelessly and/or recording locations. The distance parameter 120 may be determined based on the distances calculated using the GPS coordinates. In some embodiments, the sensor 150 may be located on (or near) the capture device 52. In one example of the sensor 150 located on (or near) the capture device 52, the sensor 150 may comprise depth-of-flight sensors covering the spherical field of view 102. In another example, the sensor 150 may be a LIDAR and/or structured-light device placed on, or near, the capture device 52. The types of sensors 150 implemented may be varied according to the design criteria of a particular implementation.

In some embodiments, the distance parameter 120 may be determined based on a depth map associated with the spherical view 102. For example, multiple capture devices 52 may capture the audio source and generate a depth map. The distance parameter 120 may be determined based on computer vision techniques.

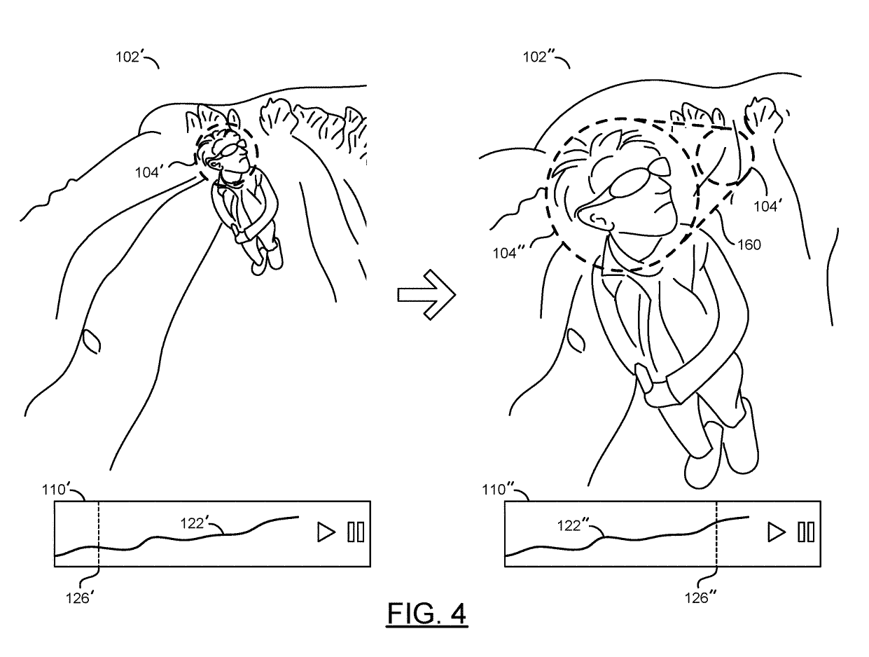

Referring to FIG. 4, a diagram illustrating tracking an audio source is shown. A first video frame 102′ is shown. A second (e.g., later) video frame 102″ is shown. In some embodiments, the first video frame 102′ may be an earlier keyframe and the second video frame 102″ may be a later keyframe. The audio source (e.g., the person talking) is shown moving closer to the capture device 52 from the first video frame 102′ to the second video frame 102″.

In the first video frame 102′, the audio source is identified by the icon 104′. The GUI portion 110′ is shown below the first video frame 102′. The timeline 126′ is shown. The audio file parameter 122′ is shown. The height of the graph of the audio file parameter 122′ may indicate a volume level of the audio stream at a particular point in time. The timeline 126′ indicates that the audio file parameter 122′ is near a beginning of the playback. At the beginning of the playback, the audio file parameter 122′ may have a lower volume level (e.g., the audio source is farther away from the capture device 52).

In the second video frame 102″, the audio source is identified by the icon 104″. The GUI portion 110″ is shown below the second video frame 102″. The timeline 126″ is shown. The audio file parameter 122″ is shown. The height of the graph of the audio file parameter 122 may indicate a volume level of the audio stream at a particular point in time. The timeline 126″ indicates that the audio file parameter 122″ is near an end of the playback. At the end of the playback, the audio file parameter 122″ may have a higher volume level (e.g., the audio source is closer to the capture device 52).

In the second video frame 102″ a tracking indicator 160 is shown. The tracking indicator 160 may identify a movement of the audio source from the location of the first icon 104′ to the location of the second (e.g., later) icon 104″. In some embodiments, the interface 100 may use keyframes and interpolation to determine the tracking indicator 160. The processors of the computing device 80 may be configured to determine the tracking indicator 160 based on position data calculated using interpolated differences between locations of the audio source identified by the user at the keyframes. For example, the icon 104′ may be identified by the user in the earlier keyframe 102′, and the icon 104″ may be identified by the user in the later keyframe 102″. The movement of the audio source may be interpolated based on the location of the icon 104′ in the earlier keyframe 102′ and the location of the icon 104″ in the later keyframe 102″ (e.g., there may be multiple frames in between the earlier keyframe 102′ and the later keyframe 102″). The audio stream (e.g., the audio file parameter 122) may be associated with the tracked movement 160 of the audio source. For example, the interpolation for the tracked movement 160 may be an estimation of the location of the audio source for many frames, based on a location of the icon 104′ and 104″ in the earlier keyframe 104′ and the later keyframe 104″, respectively. The method of interpolation may be varied according to the design criteria of a particular implementation.

In some embodiments, the interface 100 may implement visual tracking (e.g., using computer vision techniques). In some embodiments, the processors of the computing device 80 may be configured to implement visual tracking. Visual tracking may determine a placement of the audio source and modify the placement of the audio source over time to follow the audio source in a series of video frames. The audio stream may be adjusted to correspond to the movement of the audio source from frame to frame. Visual tracking may provide a more accurate determination of the location of the audio source from frame to frame than using interpolation. Visual tracking may use more computational power than performing interpolation. Interpolation may provide a trade-off between processing and accuracy.

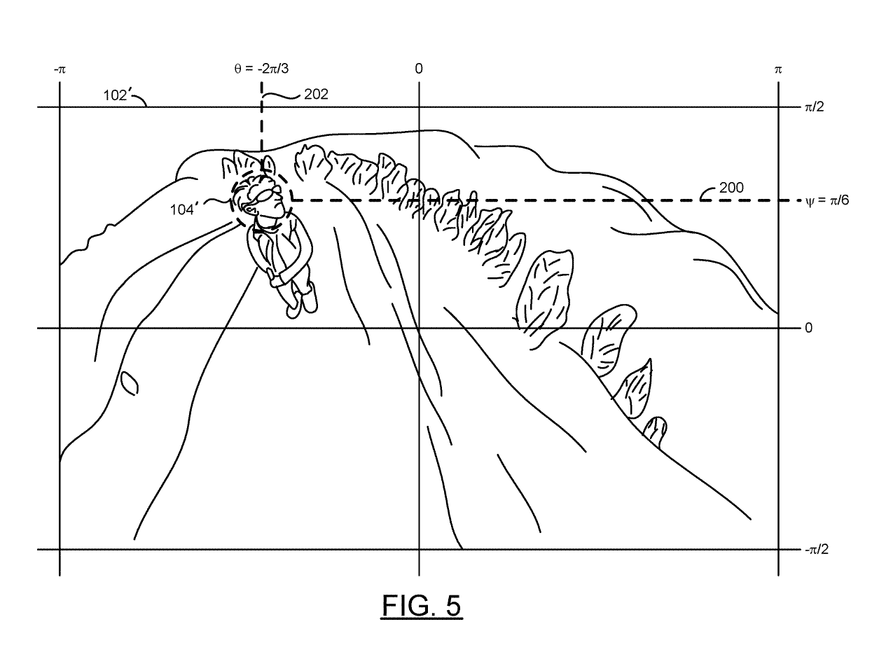

Referring to FIG. 5 a diagram illustrating determining B-format signals is shown. The video frame 102′ is shown as an equirectangular projection. The projection of the video frame 102′ may be rectilinear, cubic, equirectangular or any other type of projection of the spherical video. The user may identify (e.g., click) the flat projection of the video frame 102′ to indicate the coordinate parameters 124 from where the sound is supposed to originate (e.g., the audio source). The location may be identified by the icon 104′. A line 200 and a line 202 are shown extending from the icon 104′. In the example shown, the line 200 may indicate a value of φ=π/6 (e.g., one of the location coordinate parameters 124). In the example shown, the line 202 may indicate a value of θ=−2π/3 (e.g., one of the location coordinate parameters 124). The values for the coordinate parameters 124 may be varied according to the location of the audio source (e.g., the icon 104′).

Using the coordinate parameters 124, the audio stream may be placed in a 3D ambisonic audio space by creating the four first order B-format signals (e.g., W, X, Y and Z). A value S may be the audio source (e.g., the recorded audio captured by the audio capture device 90). The value θ may be the horizontal angle coordinate parameter 124. The value φ may be the elevation angle coordinate parameter 124. The B-format signals may be determined using the following equations:

W=S*1/sqrt(2) (1)

X=S*cos(θ)cos(φ) (2)

Y=S*sin(θ)cos(φ) (3)

Z=S*sin(φ) (4)

The calculated B-format signals may be summed with any other B-format signals from other placed audio sources and/or ambisonic microphones for playback and rendering. In some embodiments, a rotation (e.g., roll) may not need to be taken into account since the rotation may be applied in the renderer.

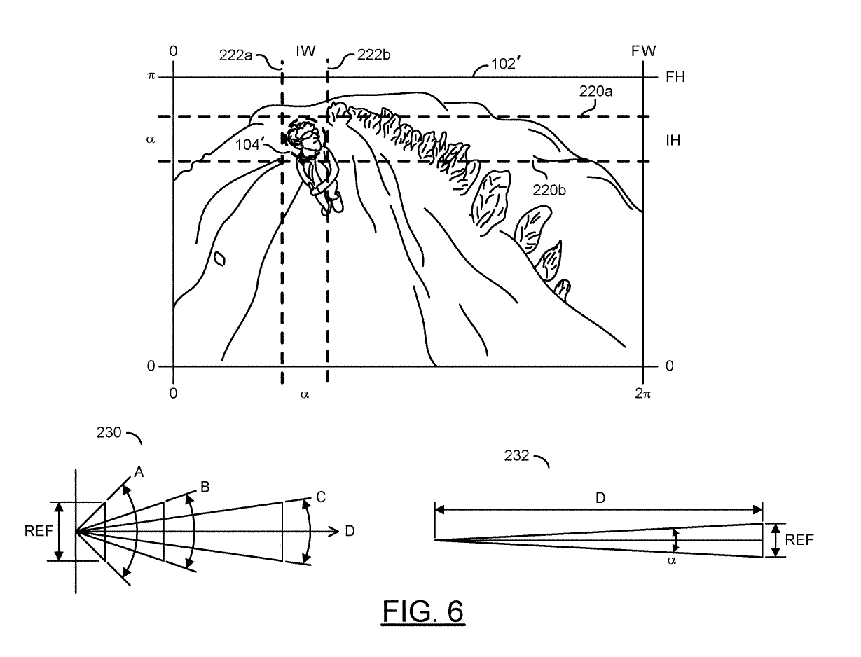

Referring to FIG. 6, a diagram illustrating a graphical representation of an audio source is shown. The equirectangular representation 102′ is shown having a frame height (e.g., FH) and a frame width (e.g., FW). For example, FH may have a value of 1080 pixels and FW may have a value of 1920 pixels. The icon 104′ is shown as a graphical identifier for the audio source on the equirectangular representation of the video source 102′.

To graphically represent the distance of an audio source, the icon 104′ may be centered at the audio source location. For example, the icon 104′ may be a symbol and/or a shape (e.g., an ellipse, a rectangle, a cross, etc.). The user may set the distance parameter 120 (e.g., by clicking and dragging, with a slider, scrolling a mouse wheel, by entering the distance manually as a text field, etc.). The size of the icon 104′ may represent the distance parameter 120. The shape of the icon 104′ may represent the direction parameter 130. In an example, with a closer audio source the icon 104′ may be larger. In another example, with a farther audio source the icon 104′ may be smaller. Lines 220a-220b are shown extending from a top and bottom of the icon 104′ indicating a height IH of the icon 104′. Lines 222a-222b are shown extending from a left side and right side of the icon 104′ indicating a width IW of the icon 104. Since the width and height of the flat (e.g., equirectangular, cubic, etc.) projection of the spherical video 102′ may be equated to angles (e.g., shown around the sides of the flat projection 102′), a relationship may be used to specify the dimensions of the icon 104′ and the distance of the audio source from the capture device 52.

A graphic 230 shows an object with a width REF. For an object of width REF an angle (e.g., A, B, and C) gets smaller as the distance D increases. For an arbitrary width REF, using the distance D as a variable, the angle may be converted into a width and height in pixels. A graphic 232 shows an object of width REF, the distance D and the angle α. The angle α may be used to determine the icon height IH and the icon width IW in the equirectangular projection 102′. In an example, of an equirectangular projection where REF=0.25 and D=2.5 with a window of 1920 by 1080 pixels (e.g., FW=1920 and FH=1080), values for IH and IW may be determined based on the angle α.

By setting a fixed reference size REF and changing the distance D to the object changes the angle α. The angle α may be converted to a certain number of pixels on the flat projection 102′. For example, the size of the icon 104′ may be calculated for an equirectangular projection spanning 2π radians of horizontal field of view and n radians of vertical field of view with the following calculations (where D is the distance of the object, REF is the reference dimension, FW and FH are the dimensions of the window, and IW and IH are the dimensions of the icon 104′):

α=2*tan₋₁(REF/2D) (5)

IW=(α/2π)*FW (6)

IH=(α/π)*FH (7)

The user may click a point on the flat projection 102′ to indicate the coordinate parameters 124 of where the sound is supposed to originate (e.g., the audio source). The user may then drag outwards (or hover over the point and scrolls the mouse wheel) to adjust the distance parameter 120. If the size REF is set appropriately (e.g., approximately 0.25 m), the indicator icon 104′ should be approximately proportional to a circle around a human head. The icon 104′ may provide the user intuitive feedback about the distance parameter 120 by comparing the scales of known objects, with the radius of the drawn shape. While the icon 104′ is shown as a dotted circle, in an equirectangular view, the projection of a circle may be closer to an ellipsis (e.g., not an exact ellipsis) depending on the placement of the icon 104′.

The distance D is then calculated with the equation:

D=REF/(2*tan(α/2)) (8)

The angle α may be the width IW in pixels converted back to radians. Gain and/or filtering adjustments may then be applied to the audio stream based on the distance parameter 120.

In some embodiments, computer vision techniques (e.g., stereo depth estimation, structure from motion techniques, etc.) may be used to build dense depth maps for the spherical video signal. The depth maps may comprise information relating to the distance of the surfaces of objects in the video frame from the camera rig 52. In an example, the user may click on the flat projection 102 to indicate the coordinate parameters 124 of where the sound is supposed to originate (e.g., the audio source). The distance of the object (e.g., audio source) may be automatically retrieved from the corresponding projected location in the depth map.

In some embodiments, a user refinement may be desired after the automatic determination of the distance parameter 120 and/or the coordinate parameters 124. A user refinement (e.g., manual refinement) may be commands provided to the interface 100. The manual refinement may be an adjustment and/or display of the placement of the icon 104 graphically on the representation of the video signal 102. In an example, the interface 100 may perform an automatic determination of the distance parameter 120 and place the icon 104 on the audio source in the video frame 102 and then the user may hover over the icon 104 and scroll the mouse wheel to fine-tune the distance parameter.

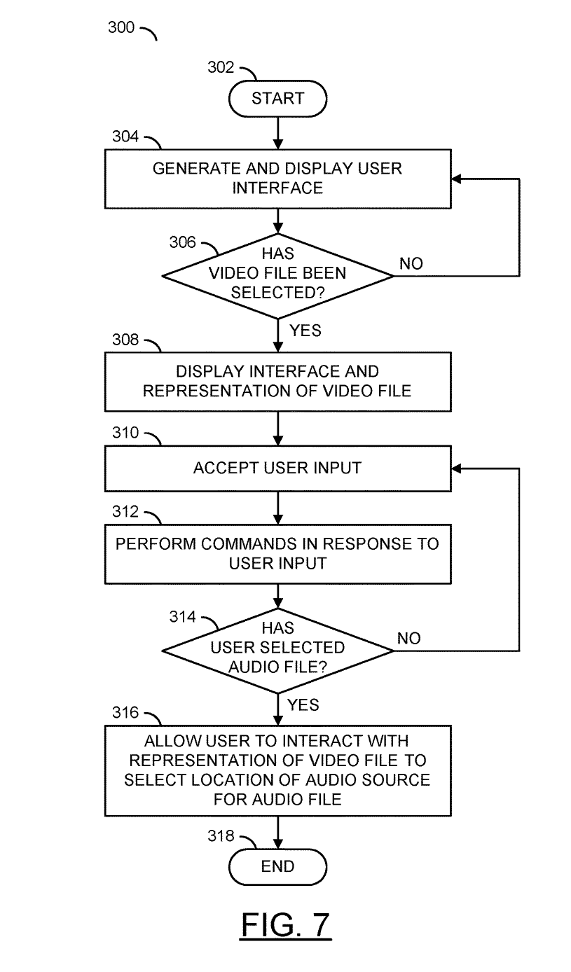

Referring to FIG. 7, a method (or process) 300 is shown. The method 300 may generate an interface to allow a user to interact with a video file to place audio sources. The method 300 generally comprises a step (or state) 302, a step (or state) 304, a decision step (or state) 306, a step (or state) 308, a step (or state) 310, a step (or state) 312, a decision step (or state) 314, a step (or state) 316, and a step (or state) 318.

The state 300 may start the method 302. In the state 304, the computing device 80 may generate and display the user interface 100 on the display 84. Next, the method 300 may move to the decision state 306. In the decision state 306, the computing device 80 may determine whether a video file has been selected (e.g., the video source, the spherical video, the 360 degree video, etc.).

If the video file has not been selected, the method 300 may return to the state 304. If the video file has been selected, the method 300 may move to the state 308. In the state 308, the computing device 80 may display the interface 100 and the representation of the video file 102 on the display 84. Next, in the state 310, the computing device 80 may accept user input (e.g., from the keyboard 86, the pointing device 88, a smartphone, etc.). In the state 312, the computing device 80 and/or the interface 100 may perform commands in response to the user input. For example, the commands may be the user setting various parameters (e.g., the distance parameter 120, the coordinate parameters 124, the audio source file parameter 122, identifying the audio source on the video file 102, etc.). Next, the method 300 may move to the decision state 314.

In the decision state 314, the computing device 80 and/or the interface 100 may determine whether the user has selected the audio file parameter 122. If the user has not selected the audio file parameter 122, the method 300 may return to the state 310. If the user has selected the audio file parameter 122, the method 300 may move to the state 316. In the state 316, the interface 100 may allow the user to interact with the representation of the video file 102 in order to select a location of the audio source for the audio file parameter 122. Next, the method 300 may move to the state 318. The state 318 may end the method 300.

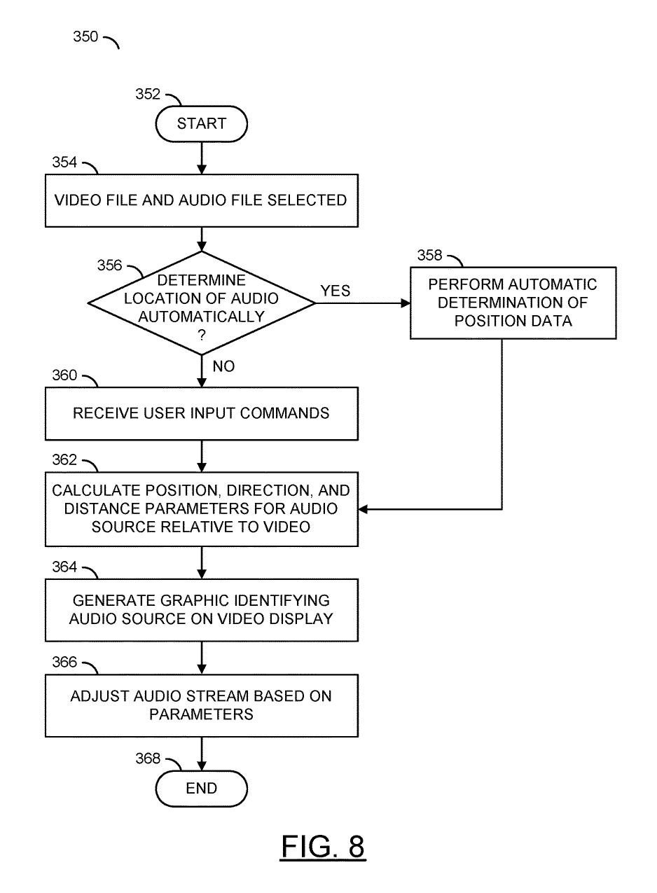

Referring to FIG. 8, a method (or process) 350 is shown. The method 350 may identify an audio source and adjust an audio stream. The method 350 generally comprises a step (or state) 352, a step (or state) 354, a decision step (or state) 356, a step (or state) 358, a step (or state) 360, a step (or state) 362, a step (or state) 364, a step (or state) 366, and a step (or state) 368.

The state 352 may start the method 350. In the state 354, the video file and the audio file parameter 122 may be selected by the user by interacting with the interface 100. Next, the method 350 may move to the decision state 356. In the decision state 356, the interface 100 and/or the computing device 80 may determine whether or not to determine the location of the audio source automatically. For example, automatic determination of the location of the audio source may be enabled in response to a flag being set (e.g., a user-selected option) and/or capabilities of the interface 100 and/or the computing device 80.

If the interface 100 and/or the computing device 80 determines to automatically determine the location of the audio source, the method 350 may move to the state 358. In the state 358, the interface and/or the computing device 80 may perform an automatic determination of the position data (e.g., the distance parameter 120, the coordinate parameters 124, the direction parameter 130, etc.). Next, the method 350 may move to the state 362. In the decision state 356, if the interface 100 and/or the computing device 80 determines not to automatically determine the location of the audio source, the method 350 may move to the state 360. In the state 360, the interface 100 and/or the computing device 80 may receive the user input commands. Next, the method 350 may move to the state 362.

In the state 362, the interface 100 and/or the computing device 80 may calculate the position coordinates parameter 124, the direction parameter 130 and/or the distance parameter 120 for the audio source relative to the video (e.g., relative to the location of the capture device 52). In the state 364, the interface 100 may generate a graphic (e.g., the icon 104) identifying the audio source on the video portion 102 of the interface 100 on the display 84. Next, the method 350 may move to the state 368. The state 368 may end the method 350.

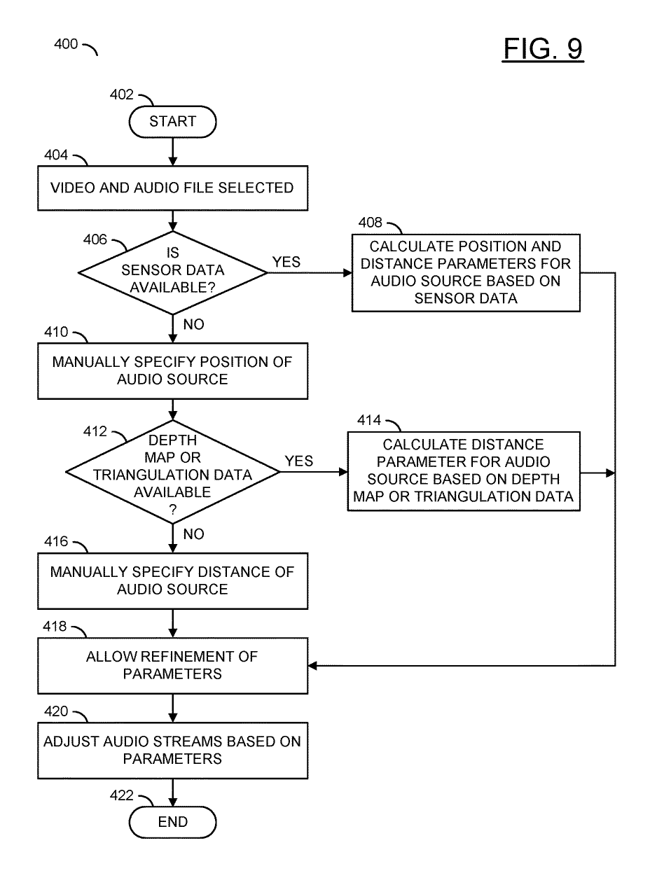

Referring to FIG. 9, a method (or process) 400 is shown. The method 400 may specify a location for audio sources. The method 400 generally comprises a step (or state) 402, a step (or state) 404, a decision step (or state) 406, a step (or state) 408, a step (or state) 410, a decision step (or state) 412, a step (or state) 414, a step (or state) 416, a step (or state) 418, a step (or state) 420, and a step (or state) 422.

The state 402 may start the method 400. In the state 404, the video file and the audio file parameter 122 may be selected by the user by interacting with the interface 100. Next, the method 400 may move to the decision state 406. In the decision state 406, the computing device 80 and/or the interface 100 may determine whether there is sensor data available (e.g., data from the sensor 150). For example, the processors of the computing device 80 may be configured to analyze information from the sensors 150 to determine position data.

If there is data available from the sensor 150, the method 400 may move to the state 408. In the state 408, the computing device 80 and/or the interface 100 may calculate the position coordinate parameters 124 and/or the distance parameter 120 for the audio source based on the data from the sensor 150. Next, the method 400 may move to the state 418. In the decision state 406, if the data from the sensor 150 is not available, the method 400 may move to the state 410. In the state 410 the user may manually specify the position of the audio source (e.g., the position coordinate parameters 124) using the interface 100. Next, the method 400 may move to the decision state 412. In the decision state 412, the computing device 80 and/or the interface 100 may determine whether there is depth map data or triangulation data available. For example, the processors of the computing device 80 may be configured to determine position data based on a depth map associated with the video source.

If there is depth map data or triangulation data available, the method 400 may move to the state 414. In the state 414, the computing device 80 and/or the interface 100 may calculate the distance parameter 120 for the audio source based on the depth map data or the triangulation data. Next, the method 400 may move to the state 418. In the decision state 412, if the depth map data is not available, the method 400 may move to the state 416.

In the state 416, the user may manually specify the distance parameter 120 for the audio source using the interface 100. Next, the method 400 may move to the state 418. In the state 418, the interface 100 may allow a manual refinement of the parameters (e.g., the distance parameter 120, the coordinate parameter 124, the direction parameter 130, etc.). Next, in the state 420, the computing device 80 and/or the interface 100 may adjust the audio streams (e.g., the audio file parameter 122) based on the parameters. Next, the method 400 may move to the state 422. The state 422 may end the method 400.

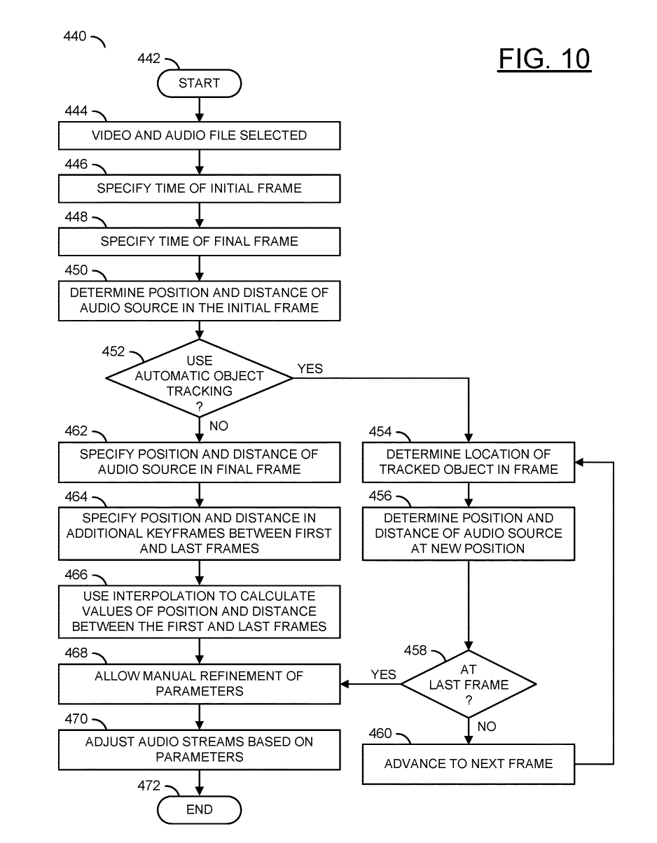

Referring to FIG. 10, a method (or process) 440 is shown. The method 440 may automate position and distance parameters. The method 440 generally comprises a step (or state) 442, a step (or state) 444, a step (or state) 446, a step (or state) 448, a step (or state) 450, a decision step (or state) 452, a step (or state) 454, a step (or state) 456, a decision step (or state) 458, a step (or state) 460, a step (or state) 462, a step (or state) 464, a step (or state) 466, a step (or state) 468, a step (or state) 470, and a step (or state) 472.

The state 442 may start the method 440. In the state 444, the video file and the audio file parameter 122 may be selected by the user by interacting with the interface 100. Next, in the state 446, a time of an initial frame of the spherical video 102 may be specified by the computing device 80 and/or the interface 100. In the state 448, a time of a final frame of the spherical video 102 may be specified by the computing device 80 and/or the interface 100. In one example, the initial frame and/or the final frame may be specified by the user (e.g., a manual input). In another example, the initial frame and/or the final frame may be detected automatically by the computing device 80 and/or the interface 100. Next, in the state 450, the computing device 80 and/or the interface 100 may determine the position coordinate parameters 124 and/or the distance parameter 120 of the audio source in the initial frame.

Next, the method 440 may move to the decision state 452. In the decision state 452, the computing device 80 and/or the interface 100 may determine whether or not to use automatic object tracking. Automatic object tracking may be performed to determine a location of an audio source by analyzing and/or recognizing objects in the spherical video frames. For example, a person may be an object that is identified using computer vision techniques implemented by the processors of the computing device 80. The object may be tracked as the object moves from video frame to video frame. In some embodiments, automatic object tracking may be a user-selectable option. The implementation of the object tracking may be varied according to the design criteria of a particular implementation.

In the decision state 452, if the computing device 80 and/or interface 100 determines to use automatic object tracking, the method 440 may move to the state 454. In the state 454, the computing device 80 and/or the interface 100 may determine a location of the tracked object in the video frame. Next, in the state 456, the computing device 80 and/or the interface 100 may determine the position coordinate parameters 124 and the distance parameter 120 of the audio source at the new position. Next, the method 440 may move to the decision state 458. In the decision state 458, the computing device 80 and/or the interface 100 may determine whether the video file is at the last frame (e.g., the final frame specified in the state 448). If the video file is at the last frame, the method 440 may move to the state 468. If the video file is not at the last frame, the method 440 may move to the state 460. In the state 460, the computing device 80 and/or the interface 100 may advance to a next frame. Next, the method 440 may return to the state 454.

In the decision state 452, if the computing device 80 and/or interface 100 determines not to use automatic object tracking, the method 440 may move to the state 462. In the state 462, the user may specify the position coordinate parameters 124 and the distance parameter 120 of the audio source in the final frame (e.g., using the interface 100). Next, in the state 464, the user may specify the position coordinate parameters 124 and the distance parameter 120 in any additional keyframes between the first frame and the last frame (e.g., the final frame) by using the interface 100. In the state 466, the computing device 80 and/or the interface 100 may use interpolation to calculate values of the position coordinate parameters 124 and the distance parameter 120 between the first frame and the last frame. For example, the interpolation may determine the tracked movement 160. Next, the method 440 may move to the state 468.

In the state 468, the computing device 80 and/or the interface 100 may allow manual refinement of the parameters (e.g., the distance parameter 120, the coordinate parameter 124, the direction parameter 130, etc.) by the user. Next, in the state 470, the computing device 80 and/or the interface 100 may adjust the audio streams (e.g., the audio file parameter 122) based on the parameters. Next, the method 440 may move to the state 472. The state 472 may end the method 440.

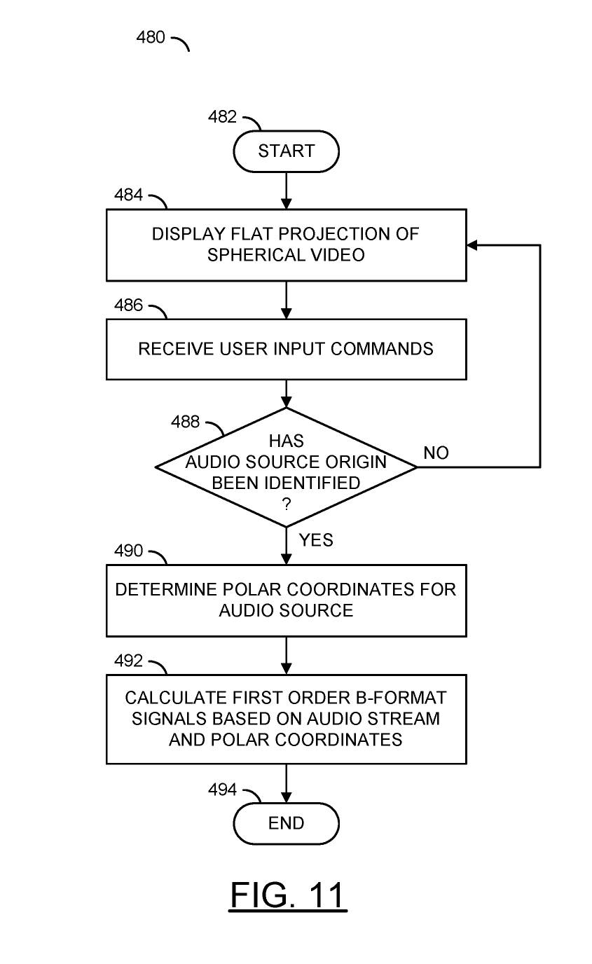

Referring to FIG. 11, a method (or process) 480 is shown. The method 480 may calculate B-format signals. The method 480 generally comprises a step (or state) 482, a step (or state) 484, a step (or state) 486, a decision step (or state) 488, a step (or state) 490, a step (or state) 492, and a step (or state) 494.

The state 482 may start the method 850. In the state 484, the computing device 80 may display the flat projection of the spherical video 102 as part of the interface 100 on the display device 84. In the state 486, the computing device 80 and/or the interface 100 may receive the user input commands. Next, the method 480 may move to the decision state 488.

In the decision state 488, the computing device 80 and/or the interface 100 may determine whether the audio source origin has been identified. If the audio source origin has not been identified, the method 480 may return to the state 484. If the audio source origin has been identified, the method 480 may move to the state 490. In the state 490, the computing device 80 and/or the interface 100 may determine the polar coordinates (e.g., the coordinate parameters 124 in a polar format) for the audio source. Next, in the state 492, the computing device 80 and/or the interface 100 may calculate first order B-format signals based on the audio stream (e.g., the audio file parameter 122) and the polar coordinate parameter 124. Next, the method 480 may move to the state 494. The state 494 may end the method 480.

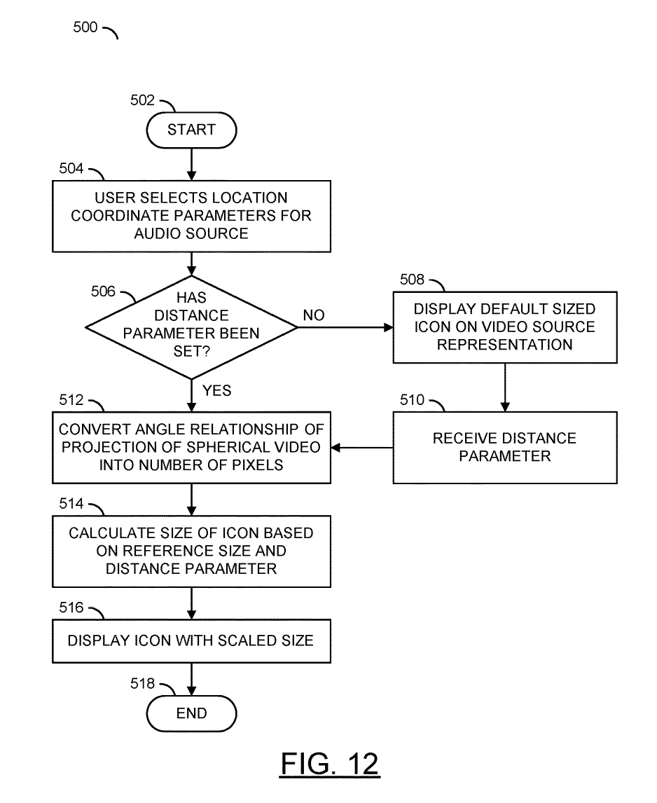

Referring to FIG. 12, a method (or process) 500 is shown. The method 500 may scale a size of the icon 104 identifying an audio source on the video 102. The method 500 generally comprises a step (or state) 502, a step (or state) 504, a decision step (or state) 506, a step (or state) 508, a step (or state) 510, a step (or state) 512, a step (or state) 514, a step (or state) 516, and a step (or state) 518.

The state 502 may start the method 500. In the state 504, the user may select the location coordinate parameters 124 for the audio source by interacting with the interface 100. Next, the method 500 may move to the decision state 506. In the decision state 506, the computing device 80 and/or the interface 100 may determine whether the distance parameter 120 has been set.

If the distance parameter 120 has not been set, the method 500 may move to the state 508. In the state 508, the interface 100 may display the icon 104 using a default size on the video source representation 102. Next, in the state 510, the interface 100 may receive the distance parameter 120. Next, the method 500 may move to the state 512. In the decision state 506, if the distance parameter 120 has been set, the method 500 may move to the state 512.

In the state 512, the computing device 80 and/or the interface 100 may convert an angle relationship of the projection of the spherical video 102 into a number of pixels. For example, the reference size may be a fixed parameter. Next, in the state 514, the computing device 80 and/or the interface 100 may calculate a size of the icon 104 based on the reference size and the distance parameter 120. In the state 516, the interface 100 may display the icon 104 with the scaled size on the video portion 102. Next, the method 500 may move to the state 518. The state 518 may end the method 500.

Audio streams may be processed in response to placing the audio sources on the interface 100. In some embodiments, the computing device 80 may be configured to process (e.g., encode) the audio streams (e.g., the audio file parameter 122). For example, the audio stream may be adjusted based on the placement (e.g., the coordinates parameter 124, the distance parameter 120 and/or the distance parameter 130) of the icon 104 on the video file 102 to identify the audio source.

The distance parameter 120 may be represented by the r parameter in the polar coordinate system. Generally, there may be no rule (or standard) on how the distance parameter 120 (e.g., the polar coordinate r) interacts with the audio signal as there is with the direction. For example, VBAP based systems may or may not take into account the distance parameter 120 (e.g., the polar coordinate r may be set to 1) based on the implementation. In another example, for ambisonic based systems there may be no objective way to set the distance parameter 120 of an audio source.

For ambisonics (and possibly VBAP), an approximation may be made using known properties of sound propagation. For example, the known properties of sound propagation in air (e.g., an inverse square law for level with respect to distance, absorption of high frequencies in air, loss of energy due to friction, the proximity effect at short distances, etc.) may be used. The properties of sound propagation may be taken into account and applied to the audio source signal before being transformed into B-format (e.g., the audio stream). Processing the audio streams based on the properties of sound propagation may be an approximation. For example, the parameters used as the properties of sound propagation may be dependent on factors such as temperature and/or relative humidity. The distance may be simulated with a sound level adjustment and a biquad infinite impulse response (IIR) filter set to low shelf (e.g., for proximity effect) or high shelf (e.g., for high-frequency absorption) with the frequency and gain parameters to be determined empirically.

Generally, the audio processing may be used to enable the audio stream playback to a user while viewing the spherical video to approximate the audio that would be heard from the point of view of the capture device 52. For example, an audio source heard from a distance farther away may be quieter than an audio source heard from a closer distance. In some embodiments, adjustments may be made to the various audio streams (e.g., to improve the listening experience for the end user viewing the spherical video). For example, since “far” sounds are quieter, a maximum range may be set to keep distant sources audible. In another example, audio levels may be adjusted by an editor to create a desired effect. In some embodiments, sound effects (e.g., synthetic audio) may be added. For an example of a spherical video that is presented as a feature film, explosions, music, stock audio effects, etc. may be added. The type of audio processing performed on the audio streams may be varied according to the design criteria of a particular implementation.

Moving the audio sources dynamically may improve post-production workflow when editing a spherical video with audio. The interface 100 may enable automation for the position coordinate parameters 124, the direction parameter 130 and/or the distance parameter 120 for the audio sources. For example, the interface 100 may be configured to automate the determination of the three parameters representing distance and location (e.g., r (distance), θ (azimuth), and φ (elevation)). In some embodiments, the automation may be performed by using linear timeline tracks. In some embodiments, the automation may be more intuitive and/or ergonomic to use the earlier keyframe 102′, the later keyframe 104′ and the interpolated tracking 160.

For keyframe automation, the user may place position/distance markers (e.g., the icon 104′, the icon 104″, etc.) on as many frames (e.g., the earlier keyframe 102′, the later keyframe 102″, etc.) in the video as desired, and the values for r, θ, and φ may be interpolated between the different keyframes. For example, the interpolation tracking 160 may be a linear or spline (e.g., cubic Hermite, Catmull-Rom, etc.), fit to the points 104′ and 104″ provided by the user as keyframes. For example, the distance parameter 120 may be determined using a linear interpolation, and the direction parameter 130 may be determined using a quadratic spline interpolation.

In some embodiments, a manual tracking may be performed by following where the audio source should be (e.g., using the mouse 88), and/or keeping the audio source centered in on the screen of a tablet or in a head mounted display while the source moves. In some embodiments, automation may be performed by implementing video tracking in the spherical video projections. For an example of a person speaking the automatic tracking may be performed using facial recognition techniques to track human faces throughout the video. For an example of a more generic object as the audio source (e.g., speakers), Lucas-Kanade-Tomasi feature trackers may be implemented. In another example, dense optical flow may be implemented to track audio sources. The method for automated determination of the distance parameter 120, the direction parameter 130 and/or the position coordinates 124 may be varied according to the design criteria of a particular implementation.

In some embodiments, curve smoothing may be used as a correction for automated detection. In another example, the user may interact with the interface 100 to perform manual corrections to the recorded automation. For example, manual corrections may be used if drawn by hand and/or based on tracked information. In some embodiments, a minimum and/or maximum value for distance may be set and the automation may stay within the range bounded by the minimum and maximum values.

The functions and structures illustrated in the diagrams of FIGS. 1 to 12 may be designed, modeled, emulated, and/or simulated using one or more of a conventional general purpose processor, digital computer, microprocessor, microcontroller, distributed computer resources and/or similar computational machines, programmed according to the teachings of the present specification, as will be apparent to those skilled in the relevant art(s). Appropriate software, firmware, coding, routines, instructions, opcodes, microcode, and/or program modules may readily be prepared by skilled programmers based on the teachings of the present disclosure, as will also be apparent to those skilled in the relevant art(s). The software is generally embodied in a medium or several media, for example non-transitory storage media, and may be executed by one or more of the processors sequentially or in parallel.

Embodiments of the present invention may also be implemented in one or more of ASICs (application specific integrated circuits), FPGAs (field programmable gate arrays), PLDs (programmable logic devices), CPLDs (complex programmable logic device), sea-of-gates, ASSPs (application specific standard products), and integrated circuits. The circuitry may be implemented based on one or more hardware description languages. Embodiments of the present invention may be utilized in connection with flash memory, nonvolatile memory, random access memory, read-only memory, magnetic disks, floppy disks, optical disks such as DVDs and DVD RAM, magneto-optical disks and/or distributed storage systems.

The terms “may” and “generally” when used herein in conjunction with “is(are)” and verbs are meant to communicate the intention that the description is exemplary and believed to be broad enough to encompass both the specific examples presented in the disclosure as well as alternative examples that could be derived based on the disclosure. The terms “may” and “generally” as used herein should not be construed to necessarily imply the desirability or possibility of omitting a corresponding element.

While the invention has been particularly shown and described with reference to embodiments thereof, it will be understood by those skilled in the art that various changes in form and details may be made without departing from the scope of the invention.

1. A system comprising:
a video source configured to generate a video signal;
one or more audio sources configured to generate audio streams; and
a computing device comprising one or more processors configured to (i) transmit a display signal that provides a representation of said video signal to be displayed to a user, (ii) receive a plurality of commands from said user while said user observes said representation of said video signal and (iii) adjust said audio streams in response to said commands, wherein (a) said commands identify a location of said audio sources in said representation of said video signal and (b) said representation of said video signal is used as a frame of reference for said location of said audio sources.

2. A method for placing one or more audio sources in a video signal, comprising the steps of:
(A) receiving said video signal;
(B) receiving one or more audio streams;
(C) displaying a representation of said video signal to a user;
(D) receiving a plurality of commands from said user while said user observes said representation of said video signal; and
(E) adjusting said audio streams in response to said commands, wherein (i) said commands identify a location of one or more audio sources and (ii) said representation of said video signal is used as a frame of reference for said location of said audio sources.

3. The method according to claim 2, wherein said video signal is a stitched video comprising a spherical field of view.

4. The method according to claim 2, wherein said audio streams comprise at least one of (a) captured sound sources of an environment and (b) sound effects.

5. The method according to claim 2, wherein said commands comprise graphically placing said audio sources onto said representation of said video signal.

6. The method according to claim 2, wherein said location comprises a distance parameter.

7. The method according to claim 2, wherein a graphical indicator is generated on said representation of said video signal corresponding to said location.

8. The method according to claim 7, wherein said graphical indicator is representative of a distance parameter of said location.

9. The method according to claim 2, wherein one or more processors are configured to automatically determine position data of said audio sources.

10. The method according to claim 9, wherein said position data is automatically determined based on at least one of (a) a depth map associated with said video signal, (b) triangulation data associated with said video signal, (c) information from one or more external sensors and (d) interpolated differences between said locations identified by said user at keyframes.

11. The method according to claim 10, wherein said external sensors comprise at least one of a wireless transmitter, a GPS device, a depth-of-flight sensor, a LIDAR device and a structured-light device.

12. The method according to claim 2, wherein said audio streams are adjusted using at least one of (i) B-format equations and (ii) metadata for object audio-based systems.

13. The method according to claim 2, wherein (i) one or more processors are configured to perform visual tracking of said audio sources and (ii) said location of said audio streams are modified over time in response to said visual tracking of said audio sources.

14. The method according to claim 2, wherein said location comprises at least one of (a) Cartesian coordinate values, (b) polar values and (c) a distance.

15. The method according to claim 2, wherein said representation of said video signal comprises a 2D equirectangular projection of a spherical field of view.

16. The method according to claim 2, wherein said video signal is a 360 degree video and said audio streams are sound fields.

17. The method according to claim 2, wherein said video signal is a rectilinear view and said audio streams are converted to at least one of (i) stereo sound tracks and (ii) multichannel sound tracks.

18. The method according to claim 2, wherein said adjustment of said audio streams comprises at least one of gain adjustments and filtering adjustments.

19. The method according to claim 2, wherein said commands comprise a manual refinement of an automatic determination of said location.

20. A system comprising:
a video source configured to generate a plurality of video streams that capture a view of an environment;
one or more audio sources configured to generate audio streams; and
a computing device comprising one or more processors configured to (i) perform a stitching operation on said plurality of video streams to generate a video signal representative of a spherical field of view of said environment, (ii) transmit a display signal that provides a representation of said video signal to be displayed to a user, (iii) receive a plurality of commands from said user while said user observes said representation of said video signal and (iv) adjust said audio streams in response to said commands, wherein (a) said commands identify a location of said audio sources in said spherical field of view and (b) said spherical field of view is used as a frame of reference for said location of said audio sources.
